(19) United States
(12) Patent Application Publication
(10) Pub. No.: US 2023/0241838 A1
(43) Pub. Date: Aug. 3, 2023

(54) THREE-DIMENSIONAL PRINTING SYSTEM

(71) Applicant: Maple Class Printing Pty Ltd, Northcote, Victoria (AU)

(72) Inventors: Nick Birbilis, Northcote, Victoria (AU); Darren Robert Feenstra, Northcote, Victoria (AU); Tony Koutsonikolas, Northcote, Victoria (AU)

(21) Appl. No.: 18/009,697

(22) PCT Filed: Jun. 11, 2021
(86) PCT No.: PCT/AU2021/050603

§ 371 Date: Dec. 9, 2022

(30) Foreign Application Priority Data
Jun. 12, 2020 (AU) 2020901950

(51) Int. Cl. B29C 64/209; B29C 64/118; B29C 64/295; B33Y 30/00; B33Y 10/00

(52) U.S. Cl. CPC B29C 64/209; B29C 64/118; B29C 64/295; B29K 2909/08; B33Y 30/00; B33Y 10/00

(57) ABSTRACT

A printing apparatus for 3D printing of feedstock. The printing apparatus comprises a hollow nozzle having an inlet and an outlet. The nozzle is mounted within a heating body that holds and heats the nozzle whereby the feedstock passing through the nozzle is heated prior to exiting the outlet. The nozzle can be mounted within the heating body such that an exterior surface of a portion of the nozzle locates outside of and extends away from the heating body to be exposed to ambient atmosphere. As a result, the temperature of the nozzle can vary across the nozzle.

### TECHNICAL FIELD

This disclosure relates to a three-dimensional printing system (herein “3D” printing system) and particularly, though not exclusively, to a 3D printing system for printing glass.

### BACKGROUND ART

Additive manufacturing methods, including 3D printing, have matured to become a viable manufacturing method for a wide range of materials such as polymers, metals, and composites.

However, the manufacturing of glass products by these methods can still encounter a variety of challenges. In particular, additive manufacturing of glass can be hindered by the ability to control the physical properties of the final product due to the general thermal properties of glass, including relatively high melting temperature and complex phase transformations.

Some 3D printing processes have been developed for glass applications using a Fused Deposition Modelling (FDM) approach which rely on gravity in order to extrude and deposit the molten glass. However, the reliance on gravity to feed the extrusion means that FDM printing may be unable to print glass with high resolution, and it can be difficult to control the stopping and starting of the extrusion of molten glass with high accuracy. Thus, it can be difficult to print highly intricate glass products, or glass products having multiple contours, thereby limiting the range of glass products which can be 3D printed by this approach. Further, 3D printers for FDM can be relatively large and expensive to operate due to the large volume of molten material that is required in order to generate the necessary flow rate under the force of gravity alone.

In some 3D printers it can be necessary to feed the feedstock into the printer nozzle continuously so as to minimise, or avoid altogether, undesirable air gaps that may hinder continuity during printing. In some 3D printers, where the feedstock input is not continuous, it can be necessary to fuse or weld the feedstock together prior to entry into the 3D printer's extrusion system. This can increase the overall size of the 3D printer, as well as increasing associated costs to produce the equipment.

Some powder-based glass 3D printing processes are also known in the art. These processes bind layers of powder together and the part is then sintered. This process can trap gas pockets inside the printed glass product. The resulting product can thus be cloudy, opaque or have a general reduction in clarity, and can also exhibit reduced strength. Some other 3D printing processes that use an FDM style approach to printing glass can result in undesirable shear and tension forces building-up between printed layers.

Some 3D printers have used a fine feedstock, where the diameter of the feedstock must equal or be in the same order of magnitude as the resolution of the deposited glass material. Generally, these methods have utilised a laser system or similar in order to heat the glass. For this reason, the feedstock typically requires a very small diameter, for example less than 1mm, in order to form detailed elements. However, using very small diameters can increase susceptibility to buckling or breakage of the feedstock if placed under any force. In addition, relatively expensive virgin materials or specialty glass materials can be required to produce such high specification glass fibres.

Some additional 3D printers have provided a nozzle that is cooled at the material entry point (i.e. at the top of the nozzle) and heated at the material exit point (i.e. at the bottom of the nozzle). This may reduce the chance of molten material leaking from the top of the nozzle. However, the transition of the glass material from relatively solid to molten glass over the length of the nozzle can result in the glass material becoming sticky within the transition zone, thereby increasing the overall flow resistance of the glass through the nozzle. Furthermore, providing a cooling system as part of the nozzle is energy inefficient and can require the overall length of the nozzle to be increased. A longer nozzle can reduce the ability of the 3D printer to retract the feedstock and temporarily stop printing, as a relatively larger amount of molten glass material is typically present within the nozzle. Moreover, the additional cooling system can also increase the overall size of the 3D printer, as well as increasing associated costs to produce the equipment.

It is to be understood that the references herein to the prior art do not constitute an admission that the prior art forms a part of the common general knowledge in the art, in Australia or any other country.

### SUMMARY OF THE DISCLOSURE

Disclosed herein is a printing apparatus for the 3D printing of feedstock. The apparatus is particularly suited for the printing of glass and will primarily be described in this context. However, it should be understood that the apparatus is suitable for the printing of other materials such as polymers/plastics, low melting point metals, composites, etc.

The printing apparatus can comprise a hollow nozzle having an inlet at a distal end thereof and an outlet. The nozzle may be further configured as set forth below.

The printing apparatus can also comprise a holder for supporting the nozzle in use. The holder can comprise a hollow therethrough to receive the nozzle therein. For example, the holder may take the form of a body or block that can be controllably heated (i.e. to in turn heat the nozzle) whereby the feedstock passing through the nozzle is heated prior to exiting the outlet.

The printing apparatus can further comprise a heater for heating the nozzle. The heater can be located within the holder between the holder and the nozzle (e.g. at or within the hollow of the holder). For example, the heater can be located in the hollow, and/or incorporated into or mounted within the holder. The heater can be configured to surround a first portion of the nozzle when located in the holder to heat the feedstock as it is fed through the nozzle from the inlet to the outlet. In this regard, the heater can heat the nozzle and/or holder to thereby heat the feedstock as it is fed through the nozzle.

The printing apparatus can be further configured such that the nozzle is mounted within the heater located at or within the holder. A nozzle exterior surface located at the first portion of the nozzle and proximal to the outlet can be surrounded by the heater/holder (i.e. to be heated thereby).

In accordance with the disclosure, the nozzle exterior surface can extend to a second portion of the nozzle that is proximal to the inlet but such that the exterior surface of the second portion of the nozzle locates outside of and extends away from the heater and the holder to the nozzle distal end to be exposed to ambient atmosphere (e.g. to ambient air). This location outside of and extension away of the exterior (i.e. outside/external) surface of the nozzle allows this part of the nozzle to be passively cooled by the ambient atmosphere (e.g. air).

An arrangement that provides for such passive cooling can avoid the cumbersome and complex active cooling systems of the prior art (i.e. that are employed for active cooling of the nozzle inlet to reduce the chance of molten material leaking from the top of the nozzle). Thus, the present apparatus can simplify the printing apparatus overall. Such an arrangement may also allow for the nozzle to be relatively short in length.

The mounting of the nozzle within the heating body may be such that the temperature of the nozzle can vary across the nozzle. In other words, the nozzle inlet can still be indirectly heated by the heater/holder, but the aforementioned passive cooling arrangement can bring about a variation in the temperature profile of the nozzle from the inlet to the outlet. As a result, the feedstock proximal to the inlet can be more viscous than the feedstock proximal to the outlet. In this regard, the temperature of the nozzle can be relatively cooler/colder proximal the inlet, and relatively warmer/hotter proximal the outlet.

This temperature variation across the nozzle can reduce the relative heating of, and thus melting of, the feedstock at the inlet. In this regard, because the feedstock entering the nozzle may not melt to the same extent as the feedstock located within a portion of the nozzle that is directly heated by the heater/holder, the feedstock at the inlet can remain more viscous than the feedstock proximal the outlet. It has been observed that this can help to reduce an undesired ‘pooling’ or ‘backflow’ effect which may otherwise occur during printing, whereby molten feedstock material may build up proximal to the inlet of the nozzle. The pooled feedstock can also be undesirable in the sense that it may be too soft to apply a positive force against (i.e. in order to controllably drive) the feedstock passing through the nozzle.

Further, whilst an entirety of the nozzle or a majority of nozzle can still be heated, the heating can occur in varying degrees across the nozzle due to such direct and indirect thermal interaction with the heater/holder. In this regard, the second portion of the nozzle that is located outside of the heater/holder is not in direct thermal contact with the heater/holder and thus can be cooler than the first portion.

In some embodiments, the nozzle inlet may still be heated sufficiently to enable individual segments of feedstock to be fused together. This may remove the need for a separate, or additional, feedstock fusing system.

In some embodiments, the heater may comprise a single heating source. In some embodiments, the heater may comprise a heating element. The heating element may take the form of one or more heat producing resistive wire coils. Resistance heating may increase the control and efficiency of the heating of the nozzle. This may help the printing apparatus to be more compact, more energy lean, safer, generally easier to control, and more economical to operate. Resistance heating can also be more versatile than other types of heating, such as laser or induction heating, because resistance heating does not require that the nozzle be formed of specific metals or materials in order to conduct the thermal energy therethrough to thereby heat the feedstock.

In some embodiments, the heater may comprise one or more layers of insulation around the heating element. In some embodiments, the one or more layers of insulation may comprise various non-conductive high temperature (e.g. refractory) materials. For example, a refractory material may be arranged between adjacent windings of the one or more resistive coils. The refractory material may be a refractory mortar or refractory fire brick (e.g. a metal oxide and/or silicate mortar/brick, etc.). Arranging of the refractory material in this way can also support the coils in use (e.g. it can prevent them from collapsing under their own weight, such as when repeatedly heated and cooled).

In some embodiments, the apparatus may comprise an extrusion system that forces the feedstock through the nozzle to be extruded through the outlet of the nozzle. The extrusion system may be one or more of a driving mechanism and/or gravity. Driving the feedstock through the nozzle by force may allow for increased control over the flow/feed rate of the feedstock when it is extruded from the nozzle. Use of a driving mechanism may improve control over the starting and stopping of extrusion from the nozzle. Use of a driving mechanism may also enable the apparatus to perform a step of retraction (i.e. to retract the feedstock from and/or exiting the nozzle). In some embodiments, applying a driving force may enable higher resolution printing. Use of a driving mechanism may decrease, or effectively remove, the need for the printing apparatus to rely on the force of gravity in order to extrude the feedstock from the nozzle.

As set forth above, the driving mechanism may apply a driving force against the feedstock in-use, whereby the feedstock is forced to move towards the nozzle outlet. In some embodiments, the driving mechanism may comprise two wheels. The two wheels may be spaced from each other so as to locate and apply the driving force against opposing sides of the feedstock. In such embodiments the feedstock may comprise a solid rod, bar or segment against which the driving wheels may act. In some embodiments, one or each of the two wheels may be able to resiliently move so as to adjust a width of the spacing relative to the opposing one of the two wheels whilst maintaining the application of the driving force against the feedstock in-use. Surprisingly, this may allow for lower purity input materials to be used for the feedstock and/or for the feedstock to have a variable cross-sectional width. In some embodiments, the wheels may be spring-loaded.

In some embodiments, the feedstock may be supported to be in alignment with, and guided into, the nozzle inlet by one or more guides. Such guides may reduce the need for manual adjustment and alignment of the feedstock during operation of the printing apparatus.

In alternative embodiments, the driving mechanism may comprise an auger within a mixing chamber, the auger being configured to apply the driving force against the feedstock. An auger may be able to drive the less viscous heated material into the nozzle; or in embodiments where the feedstock is in the form of particles, such as a powder or glass cullet, the particles may be sufficiently fine whereby the auger may drive the feedstock particles into the nozzle even without the mixing chamber being heated.

In some embodiments, the feedstock may comprise at least one of glass or glass-ceramic material. In some embodiments, the feedstock may comprise a viscoelastic material. In some embodiments, the feedstock may have a uniform cross-section. In other embodiments, the feedstock may have a non-uniform cross-section. In some embodiments, the feedstock may not have the same cross-sectional width as the desired output resolution of the nozzle outlet. Thus, the feedstock may not need to be thin in order to print high resolution products. Again, this is a surprising result of the driving mechanism and/or guides and/or control parameters of the present printing apparatus.

In some embodiments, the nozzle may be removable from the holder. The nozzle may thus be interchangeable with other nozzles that potentially have different dimensions or material properties. For example, the nozzle may be interchanged with a nozzle having a different nozzle outlet size. In a further example, the nozzle may be interchanged with a nozzle formed of a material that is capable of withstanding greater/higher temperatures.

In some embodiments, the nozzle may be formed from a conductive material. In other embodiments, the nozzle may be formed from a non-conductive material. For example, a non-conductive material nozzle, such as a ceramic, may enable the 3D printing of higher melting point materials.

In some embodiments, the printing apparatus may be operated at temperatures between 700 and 900 degrees Celsius.

In some embodiments, the printing apparatus may be operated at temperatures above 1000 degrees Celsius.

In some embodiments, the printing apparatus may be operated such that, in use, a temperature of the outlet can be higher than a “softening point” of the material (i.e. the temperature where the material begins to deform under its own weight). When the feedstock is glass, its annealing temperature may be in the range of 400-500° C., and more particularly, in the range 450-485° C. For glass, this range corresponds with the so-called stress-relief point or annealing point of the glass. The nozzle outlet may be operated at a temperature that is above the softening temperature (approximately double the annealing temperature).

In some embodiments, the printing apparatus may further comprise a sleeve. The sleeve can be configured for location within the hollow of the holder whereby the nozzle can be located within the sleeve in use. The sleeve can be formed from a non-electrically conductive, high temperature resistant material (e.g. an insulating material such as a ceramic). The apparatus may be further configured such that the heater is located in adjacency of the sleeve (e.g. between the sleeve and the holder). For example, when the heater takes the form of heat producing resistive wire coils, the coils can be wound around the sleeve. For example, the heater can, in effect, be ‘sandwiched’ between the holder and the sleeve.

In some embodiments, the printing apparatus may cooperate with a temperature-controlled chamber, as set forth below. In this regard, the printing apparatus may be configured to print onto a platform located within the temperature-controlled chamber.

Also disclosed herein is a printing apparatus for 3D printing of glass from a solid glass rod feedstock. The printing apparatus can be as set forth above. In this regard, the printing apparatus can comprise a hollow nozzle that has an inlet and an outlet. Further, the nozzle can comprise a first portion located proximal to the outlet and a second portion located proximal to the inlet. The solid glass rod can be fed into the nozzle via the inlet. Additionally, the printing apparatus can comprise a holder for supporting the nozzle in use. The holder can comprise a hollow therethrough to receive the nozzle therein. Moreover, the printing apparatus can comprise a heater for the nozzle. The heater can be located at or within the holder and can be configured to surround the nozzle when located therein to heat the feedstock as it is fed through the nozzle from the inlet to the outlet.

In accordance with the disclosure, the heater can comprise one or more heat producing resistive coils. Adjacent windings of the one or more coils can have a refractory material (e.g. a refractory mortar) arranged therebetween to support the coils in use. As set forth above, by arranging the refractory material (e.g. mortar) in this way, this can support the coils in use. For example, it can prevent the coils from collapsing under their own weight, such as when repeatedly heated and cooled.

Also disclosed herein is a printing apparatus for printing of feedstock onto a platform in three-dimensions. Again, the printing apparatus can be as set forth above. In this regard, the printing apparatus can comprise a hollow nozzle having an inlet and an outlet. Also, the nozzle can comprise a first portion located proximal to the outlet and a second portion located proximal to the inlet. Further, the printing apparatus can comprise a holder for supporting the nozzle in use. The holder can comprise a hollow therethrough to receive the nozzle therein. Additionally, the printing apparatus can comprise a heater for the nozzle. The heater can be located at or within the holder. The heater can be configured to surround the nozzle when located therein to heat the feedstock as it is fed through the nozzle from the inlet to the outlet.

In accordance with the disclosure, the printing apparatus can further comprise a temperature-controlled chamber in which the platform is located. The temperature-controlled chamber can be heated to a temperature that is suitable for printing of the feedstock onto the platform. Further, the heater can be located at or within the holder so as to not extend into the temperature-controlled chamber. In other words, by not extending into the chamber, the heater does not directly heat or interfere with the chamber atmosphere. Rather, the heater primarily heats the holder/nozzle. This allows for better control of temperature in the chamber.

For example, the temperature-controlled chamber may be configured such that, during printing of the feedstock onto the platform, the chamber may be heated to a temperature that is above an annealing temperature of the material of the feedstock. Further, the nozzle may be heated to a temperature that is above an softening temperature of the material. Typically, the temperature to which the nozzle is heated is higher than the softening temperature otherwise the feedstock material may solidify and so be unable to be extruded through the nozzle.

Further, after printing (e.g. after an article has been printed on the platform), the temperature of the chamber may be reduced to the annealing temperature of the material of the feedstock. This can help to relieve stress in the printed article and may also facilitate its dislodgement from the platform. Conversely, during such chamber temperature reduction, the nozzle may still be kept heated (e.g. for printing of a further article).

Also disclosed herein is a 3D printing system. The 3D printing system can comprise printing apparatus as set forth above. The printing apparatus can also comprise a temperature-controlled chamber. In the 3D printing system, the feedstock exiting the nozzle outlet can be deposited on a platform located within the temperature-controlled chamber.

The temperature-controlled chamber may be configured and operated as set forth above. In this regard, in some embodiments of the system, in use, the temperature within the temperature-controlled chamber may be controlled to be above the annealing temperature of the material and, after printing, may be reduced to the annealing temperature of the material. Further, in some embodiments of the system, in use, the temperature of the nozzle outlet can be higher than the softening point of the material (i.e. higher than the softening temperature and considerably higher than the annealing temperature to prevent material solidification in the nozzle).

Use of a temperature-controlled chamber in conjunction with the printing apparatus may allow for the extruded (i.e. printed) material to be controllably annealed whereby internal stresses between layers of the printed 3D product may be at least partially relieved. This may reduce the likelihood of the printed 3D product breaking due to internal stresses or thermal shock which can occur in embodiments where the printed 3D product is exposed to rapid cooling. This may also help the 3D printing system when printing more complex geometries. As set forth above, during printing, the temperature of the chamber may be above the material's annealing temperature, and after printing the temperature of the chamber may be reduced to the material's annealing temperature.

In some embodiments of the system, the feedstock may be deposited on a platform that is located within the temperature-controlled chamber. In some embodiments of the system, when the feedstock is deposited on the platform in use, the feedstock may have a viscosity whereby the feedstock can adhere to the platform.

In some embodiments of the system, the platform may be movable relative to the outlet along one or more axes. In some embodiments of the system, the platform may move along a pre-programmed route that is controlled by a computer program. In some embodiments of the system, the platform may be moved by one or more actuators.

In some embodiments of the system, the platform may be supported on a support that protrudes through a wall of the temperature-controlled chamber. The aperture in the wall of the temperature-controlled chamber may be at least partially covered by insulation.

Also disclosed herein is a method of printing feedstock in three-dimensions. The method can employ the printing apparatus and/or or the 3D printing system as set forth above.

The method can comprise locating a hollow nozzle in a holder. The nozzle can have an inlet at a distal end thereof and an outlet. The method can also comprise passing the feedstock through the hollow nozzle. The method can also comprise directly heating a first portion of the nozzle proximal to the outlet by a heater located between the holder and the nozzle and passively cooling only a second portion of the nozzle proximal to the inlet by exposing the second portion to ambient atmosphere.

As set forth above, such passive cooling can avoid the complexities of the prior art active cooling systems and can simplify the method of printing. Further, such passive cooling can help to prevent pooling/backflow of feedstock in and back out of the nozzle inlet.

In some embodiments of the method, the first portion of the nozzle may be heated by a heat source. The second portion of the nozzle may, in addition to such passive cooling, be indirectly heated by the same heat source such that, in use, the second portion of the nozzle can still be heated, but can be cooler than the first portion of the nozzle. In some embodiments of the method, the second portion of the nozzle may be exposed to ambient air.

Also disclosed herein is a method of printing feedstock onto a platform in three-dimensions. Again, the method can employ the printing apparatus and/or the 3D printing system as set forth above.

The method can comprise locating the platform in a temperature-controlled environment that is heated to above an annealing temperature of a material of the feedstock. The method can also comprise passing the feedstock through a heated nozzle to print onto the platform to form a printed article in the environment. The method can further comprise reducing the temperature in the temperature-controlled environment to the annealing temperature of the material of the printed article. As set forth above, this can help to relieve stress in the printed article and may also facilitate its dislodgement from the platform.

Also disclosed herein is a method of printing feedstock in three-dimensions. Again, the method can employ the printing apparatus and/or or the 3D printing system as set forth above.

The method can comprise passing the feedstock through a hollow nozzle having an inlet and an outlet. The nozzle can be heated to melt the feedstock in the nozzle. The method can also comprise controlling viscosity of molten feedstock and flow rate of feedstock into/exiting the nozzle.

In accordance with the disclosure, viscosity of molten glass and flow rate of solid glass into/molten glass exiting the nozzle can be controlled to promote the passage of the molten feedstock through the nozzle from the inlet to the outlet. As set forth above, this controlling of the viscosity and flow rate can help to prevent pooling/backflow of feedstock in and back out of the nozzle inlet.

When the terms “controlling” and “controlled” are used herein, it should be understood that this can include preconfiguring, pre-setting, pre-programming, etc. of the one or more of the parameters. In this regard, a parameter can be “controlled” by setting or establishing it from or before the outset of printing.

Also disclosed herein is a method of printing feedstock onto a platform in three-dimensions. Again, the method can employ the printing apparatus and/or or the 3D printing system as set forth above.

The method can comprise coating the platform with a mixture that comprises a high temperature powdered release agent and water. The release agent may be a kiln wash, batt wash, etc (e.g. a blend of alumina oxide, kaolin and silica). The method can also comprise drying the platform to remove the water. The method can further comprise passing the feedstock through a heated nozzle to print onto the platform to form a printed article. The method can additionally comprise removing the printed article from the platform once it has sufficiently cooled. In accordance with the disclosure, the release agent can facilitate such removal of the printed article from the platform.

### BRIEF DESCRIPTION OF THE DRAWINGS

Embodiments will now be described by way of example only, with reference to the accompanying drawings in which:

FIG. 1 is a side view of a first embodiment of the disclosed 3D printer system.

FIG. 2 is a section front view taken through A-A of the embodiment of FIG. 1.

FIG. 3 is a section front view detail taken through A-A of the embodiment of FIG. 1, showing a close-up of view of the heating body, extrusion system and guide blocks.

FIG. 4 is a close-up section front view detail of the heating body of the embodiment of FIG.l.

FIG. 5 is a close-up section front view of the nozzle of the embodiment of FIG. 1.

FIGS. 6A and 6B are respectively a close-up front view and a close-up section front view of an embodiment of a feeder system for the disclosed 3D printer system.

FIG. 7 is a schematic perspective view of a further embodiment of the disclosed 3D printer system.

FIG. 8 is a side view of the embodiment of FIG. 7.

FIG. 9 is a close-up schematic view of an upper portion of the further embodiment of the disclosed 3D printer system of FIG. 7.

FIG. 10 is a close-up schematic view of the extrusion system and guide blocks of the further embodiment of the disclosed 3D printer system of FIG. 7.

FIG. 11 is a close-up schematic view taken from below an outlet of the nozzle and the print platform located within the temperature-controlled chamber of the further embodiment of the disclosed 3D printer system of FIG. 7.

FIGS. 12A and 12B are respectively a close-up front view and a close-up sectional front view of an embodiment of an auger-style feed and extrusion system.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the apparatus and system of the present disclosure, as generally described herein and illustrated in the drawings can be arranged, substituted, combined, separated and designed in a wide variety of different configurations, all of which are contemplated in this disclosure.

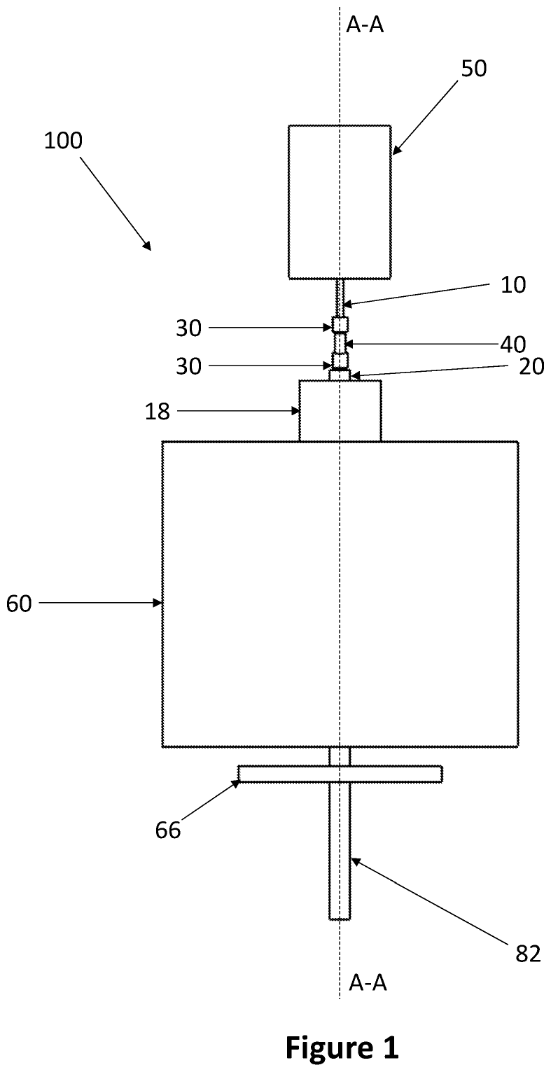

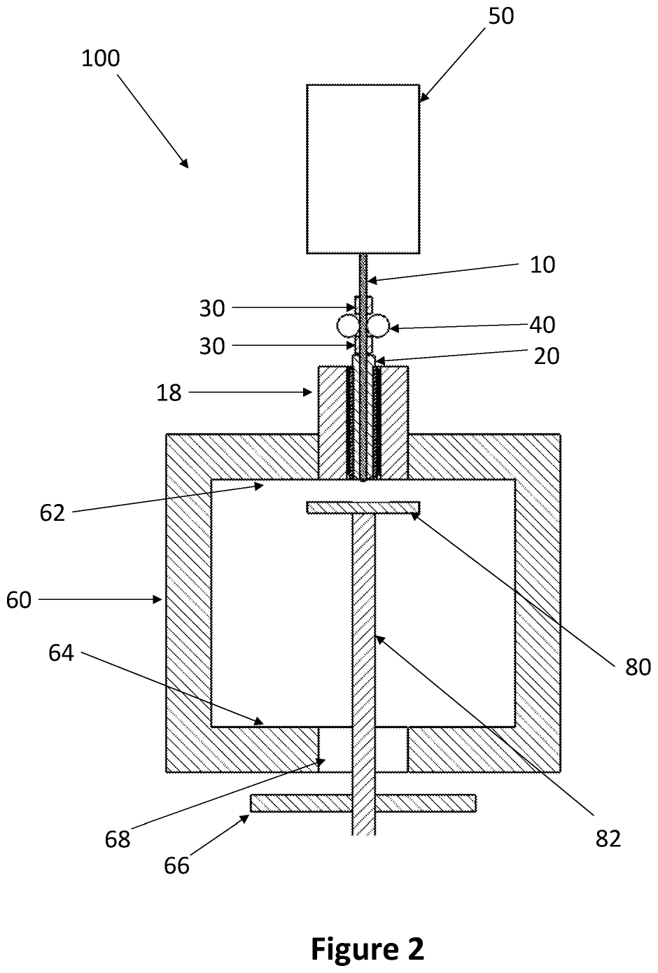

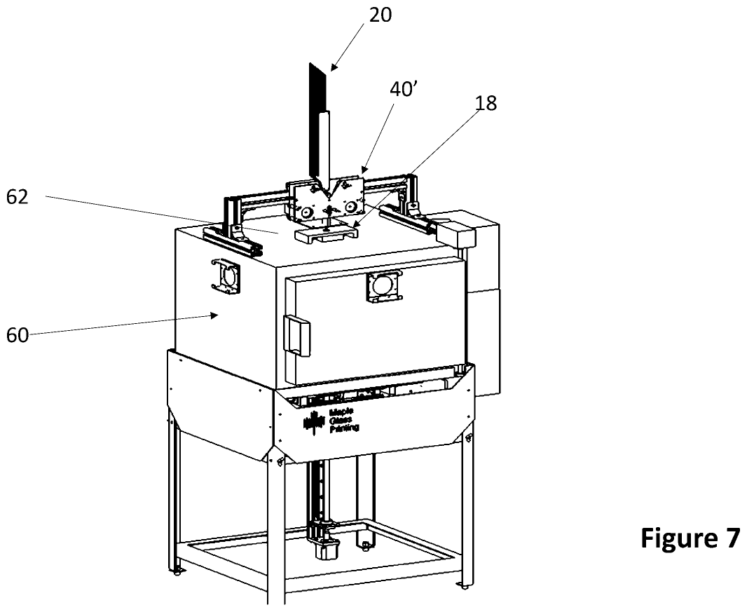

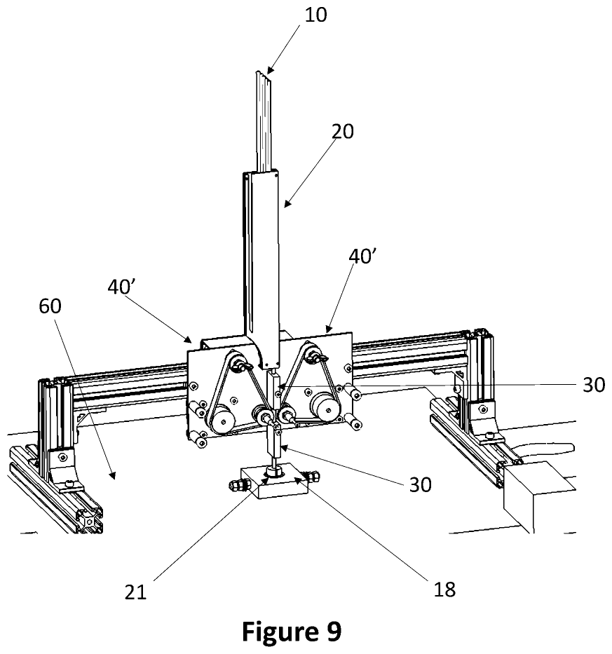

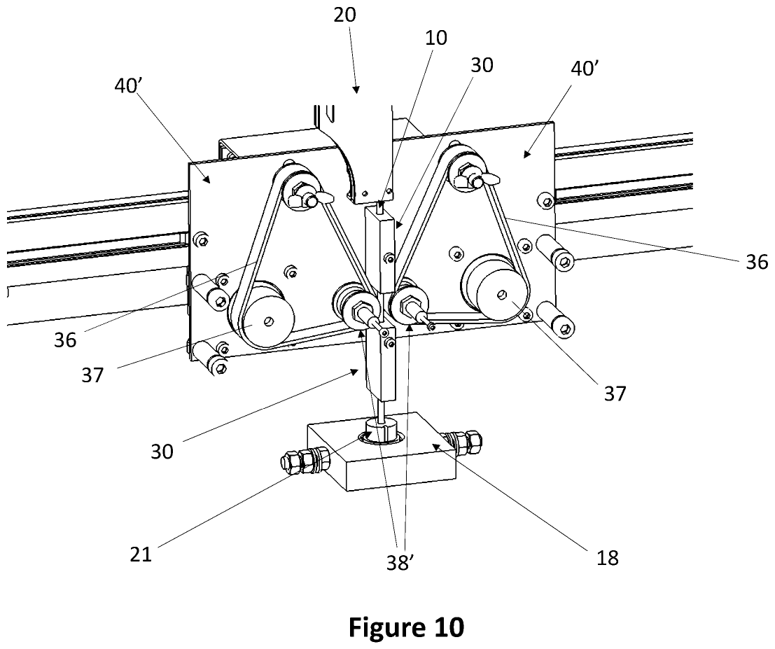

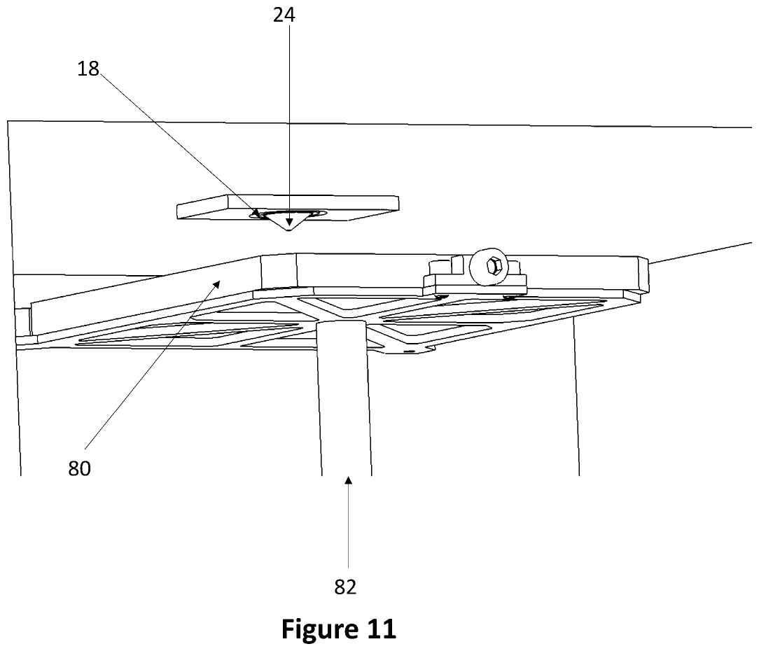

FIGS. 1 to 5 illustrate the components of a first embodiment of a 3D printer system 100 in accordance with the present disclosure. FIGS. 7 to 11 illustrate a further embodiment of a 3D printer system 100′ in accordance with the present disclosure. Where like numerals are used, the referenced features are considered to be similar or the same unless described as being otherwise.

The 3D printer system 100 can be used to print glass in three dimensions. The design of the disclosed 3D printer system 100 enables the use of feedstock formed from either virgin or recycled glass inputs. For example, the disclosed 3D printer system 100 can be used to process and print from low-grade economic glass.

In addition, the 3D printer system 100 can utilise commonly available materials that are economical and easy to manufacture. This may allow for mass production and improve the affordability of the 3D printer system 100. Alternative feedstock materials can include, but are not limited to, low melting point metals (i.e. with melting points lower than 1000 degrees Celsius) such as aluminium or copper, or high melting temperature polymers such as PEEK where nozzle temperatures may reach up to 450 degrees Celsius during printing.

The disclosed 3D printer system 100 can also be used to print a composite product containing more than one material, or variants of a material having more than one material property. For example, a mixture of materials can be introduced simultaneously within the 3D printer system 100. In a further example, two or more 3D printer systems 100 can be used in a synchronised manner to print a singular product, with each system contributing a unique feedstock material into the printed product and thereby forming together a hybrid material. For example, one possible composition for the feedstock can be soda lime glass that comprises ˜70% SiO2, ˜10-15% Na2O, ˜10% CaO as major constituents by weight percentage, with other additions being possible, which may vary considerably in weight percentage. It is noted that by nature, the composition of glass can vary greatly.

The feedstock 10 can be chosen to have a specific composition and properties such as geometry. For example, for higher resolution printing where the product has finer extrusion geometries, it may be helpful to use feedstock having a smaller cross-sectional width (or smaller diameter in embodiments where a circular rod geometry is used for the feedstock). The smaller cross-sectional width of the input feedstock can effectively decrease the pressure applied by the incoming feedstock as it enters a nozzle 20. This can assist with controlling the flow rate and precision of the extrusion. A rod of feedstock can, for example, be substantially circular in cross-sectional shape and have a straight length that can typically be between 300 mm and 400 mm long with a diameter of between 3 mm and 6 mm. As would be appreciated by one skilled in the art, many other sizes and geometries of feedstock can be used, with each being best suited for a different printing resolution.

The 3D printer system 100 comprises a feeder system 50 that feeds the input material (i.e. the feedstock 10) into an extrusion system 40. The extrusion system 40 applies a driving force to the feedstock 10 that pushes the feedstock 10 downwards into the nozzle 20 from which the melted feedstock 10 material is extruded onto a print platform 80 to create a 3D printed object layer by layer. The components of the 3D printer system are generally able to be arranged in a vertical orientation whereby the solid or semi-solid feedstock 10 material that is input into the system can be fed into the nozzle inlet 22 from above the inlet, and whereby heated feedstock 10 material can be extruded from the bottom of the nozzle 20 through the nozzle outlet 24.

The nozzle 20 can be made from a high temperature, corrosion resistant metallic material, such as an Inconel alloy, that allows for control when designing and forming the precise geometry required for the nozzle 20. Alternatively, the nozzle 20 can be formed from high temperature refractory (e.g. ceramic) materials that enable feedstock materials having higher melting temperatures to be extruded therethrough.

The nozzle inlet 22 is sized (e.g. has a diameter) to be the same size, or larger, than the size (e.g. diameter) of the feedstock 10 being used by the 3D printer system 100. This allows for appropriate feeding of the feedstock 10 into the nozzle 20. Thus, the feedstock 10 only comes into contact with the nozzle 20 and does not directly contact a heater (e.g. heat producing resistive coils 15) for heating of the nozzle, nor does it directly contact a nozzle holder in the form of a heating block or body 18.

Where a nozzle is provided that has a smaller nozzle inlet 22 (e.g. of smaller diameter/area), a reduction of the force required from the extrusion system 40 to effectively drive the feedstock 10 into the nozzle 20 occurs (i.e. so as to cause molten feedstock 10 material to be extruded from the nozzle outlet 24). This is because pressure=force/area; i.e. as the nozzle inlet diameter decreases (i.e. area decreases) then the same force from the extrusion system will provide a larger pressure. Likewise, a nozzle 20 having a larger nozzle outlet 24 (e.g. larger diameter) can decrease the force required from the extrusion system 40 in order to effectively drive the feedstock 10 into the nozzle 20 (i.e. so as to cause molten feedstock 10 material to be extruded from the nozzle outlet 24). Further, the size of the nozzle outlet 24 can be formed to correspond to the desired level of printing resolution. For example, for higher resolution printing, a smaller nozzle outlet 24 can be used. Furthermore, a nozzle 20 having a larger nozzle body 26 can increase the force required from the extrusion system 40 in order to effectively extrude feedstock 10 material from the nozzle outlet 24, due to the nozzle inlet diameter increasing (i.e. area increases), and hence a higher force is required to achieve the same extrusion pressure.

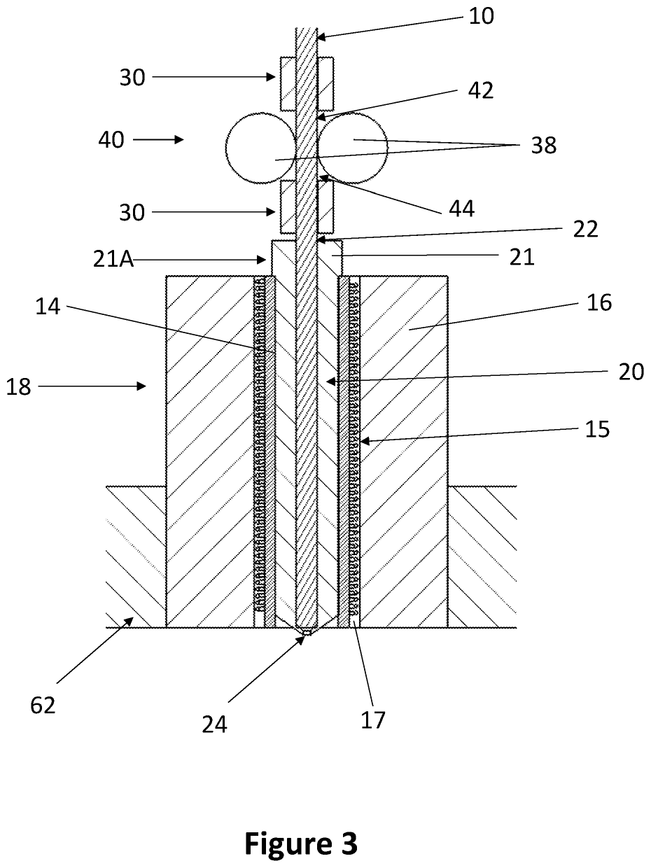

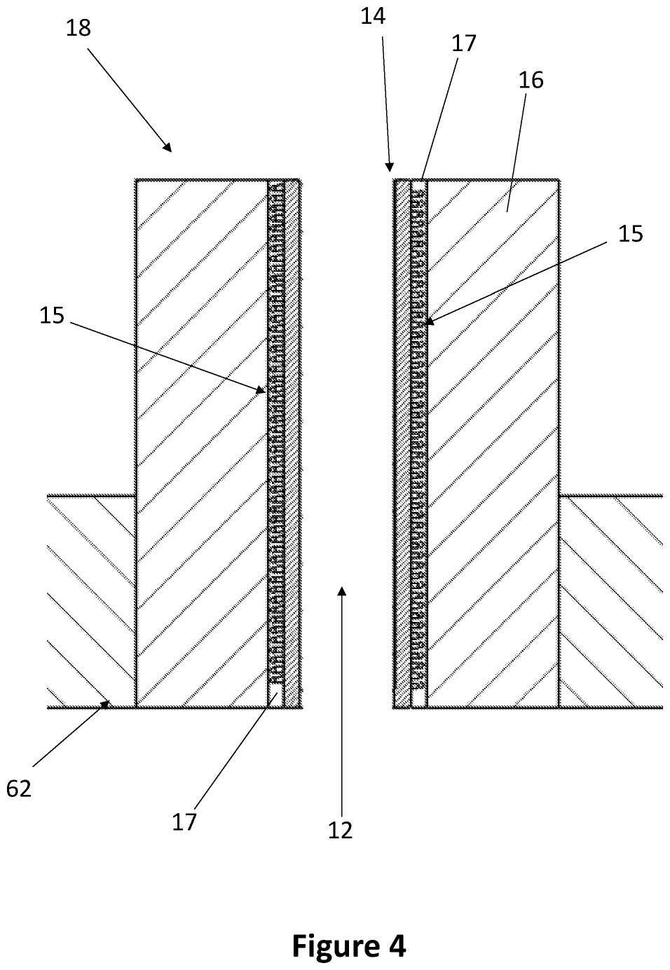

Referring to FIGS. 3 and 4, it will be seen that the nozzle 20 is to be located in the heating body 18 within an inner sleeve 14. Sleeve 14 can be formed from a non-electrically conductive high temperature resistant material (e.g. an insulating material such as a ceramic). A heater in the form of heat-producing resistive coils 15 is located adjacent to sleeve 14, the coils 15 being located within an annulus 17 that is defined between the sleeve 14 and an outer layer of high temperature insulative material block 16. The coils 15 can effectively be sandwiched between the sleeve 14 and block 16. Together, the sleeve 14, coils 15 and block 16 define the heating body 18 which can be temperature-controlled and which, in turn, acts as both a heater and holder (i.e. retainer) for the nozzle 20.

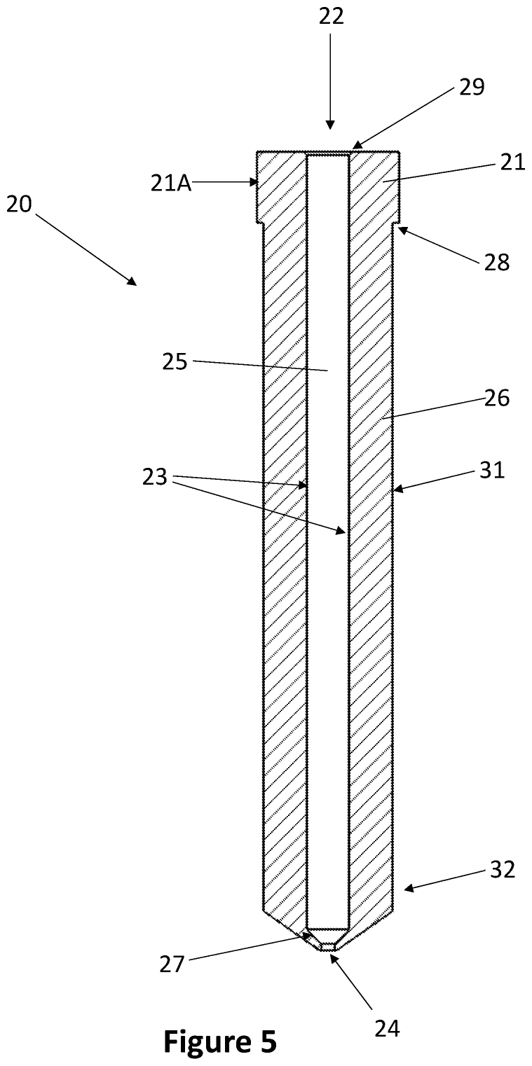

As best shown in FIG. 3 (with features of the nozzle also being shown in FIG. 5), the nozzle 20 is mounted within the heating body 18 such that a portion 21A of an exterior surface 31 of the nozzle of locates outside of and extends away from the heating body 18. Thus, the outside (or externally facing) surface 21A of a second portion 21 of the nozzle 20 is exposed to ambient atmosphere (e.g. air), resulting in the nozzle portion 21 being passively cooled. This can avoid the cumbersome and complex active cooling systems of the prior art (i.e. in the prior art, active cooling of the nozzle inlet is employed to reduce the chance of molten material leaking from the top of the nozzle). Arranging the nozzle 20 in heating body 18 in this way can thereby simplify the system and also allow for the nozzle to be relatively short in length. It can also result in the temperature of the nozzle 20 varying across the length of the nozzle. Whilst the nozzle portion 21 can still be indirectly heated by the heating body 18 (e.g. by heat conduction), the passive cooling of portion 21 brings about a variation in the temperature profile of the nozzle from the inlet to the outlet. As a result, feedstock proximal to the nozzle inlet 22 tends to be more viscous than feedstock proximal to the outlet 24 (i.e. the temperature of the nozzle can be relatively cooler/colder proximal the inlet 22, and relatively warmer/hotter proximal the outlet 24). Thus, passive cooling can also help to prevent pooling/backflow of feedstock.

The sleeve 14 and block 16 also act to insulate the thermal energy produced by the resistive coils 15 which can improve the thermal efficiency of the system. Furthermore, such insulation can help reduce steep fluctuations of the temperature experienced by the nozzle 20, thereby improving control and uniformity of extrusion/extrusion flow rates. Further, by forming sleeve 14 from an electrically non-conductive material, the nozzle 20 can be electrically insulated from the heat producing resistive coils 15 to prevent any accidental short circuiting or power limitation during use. Where the nozzle 20 is not formed from an electrically conductive material (e.g. a ceramic), the sleeve 14 may not be required.

A single (long) coil or multiple heat-producing resistive coils 15 can be provided which are configured to wrap around and adjacent to the nozzle 20 in use. Using resistive coils, as well as the non-conductive high temperature sleeve 14, can allow the nozzle 20 to be formed a range of materials, such as high temperature stable metals and ceramics. By contrast, heating by other methods such as laser or induction can limit the nozzle material to only a select range of compatible metals.

Use of resistive coils 15 can also allow the heating body 18 to be of a more compact design, which can enable the nozzle 20 to also be formed with a relatively short length. A relatively short length nozzle 20 can perform more effectively during retraction, such as when it is desired to momentarily cease extrusion of the molten feedstock 10. Moreover, a relatively short length nozzle 20 can exhibit relatively limited undesirable oozing or leakage of molten feedstock 10 when not extruding, as the overall mass/volume of the molten feedstock 10 contained within the nozzle 20 is reduced.

The heat-producing resistive coils 15 can be firmly held in place within the heating body 18 (i.e. between the sleeve 14 and block 16). In this regard, the space between the outer block 16 and inner sleeve 14, as well as the space between adjacent windings of the coils 15, can be filled with a refractory material such as a refractory mortar or refractory fire brick. Suitable mortars and bricks include e.g. metal oxide and/or metal silicate mortars/bricks. A benefit of a mortar is that it can, effectively, be injected into the annulus 17, whereas a brick requires passages for the coils to first be formed into a suitable e.g. tubular brick, and then the brick is arranged in the annulus 17. In either case, arranging of the refractory material in this way can both insulate and support the coils in use. For example, the refractory material can serve to trap heat within the heating body 18, and it can prevent the coils 15 from sagging/collapsing under their own weight (which may occur as the coils weaken from repeated heating to elevated temperatures and cooling over prolonged periods of time). Such a sagging of coils can result in contact between adjacent windings of the coil thus leading to short circuiting and heater failure.

A particularly suitable refractory mortar has been found to be TUFSET SUPER™ marketed by Vesuvius Australia. This mortar comprises a mix of alumina oxide, sodium silicate, quartz, ferric oxide and titanium oxide and is suitable for use as a heat containment lining for industrial furnaces and the like. A suitable fire brick is supplied by Skamol Asia Pacific under the names B6, LBK23, LBK26, LBK28, LBK30, TDM23, TDM26 and comprises quartz, cristobalite and kaolin.

As best shown in FIG. 4, the block 16 of heating body 18 is formed to have an interior hollow 12. When the coils 15 and inner sleeve 14 are located in the hollow 12 of block 16, the internal diameter at hollow 12 (i.e. internal diameter of sleeve 14) generally corresponds to the outer diameter and shape of the nozzle body 26. The arrangement is such that the nozzle 20 can be removably insertable 5 into hollow 12.

Referring to FIG. 5, the nozzle body 26 comprises an exterior surface 31 that extends from a first portion 32 located proximal to the nozzle outlet 24 to the second portion 21 located proximal to the nozzle inlet 22. A ledge 28 projects outwardly, proximal to, and inset from the nozzle inlet 22 near to but inset from a distal end of the nozzle 20. The ledge 28 forms a short section of the exterior surface 31. The ledge 28 extends outwardly to a sufficient extent being enough to oppose and rest above the upper surface of the heating body 18 (i.e. as shown in FIG. 3, the ledge can rest on and engage with an upper end of sleeve 14). The nozzle inlet 22 and the second portion 21 of the nozzle 20 are thus restricted from passing into the interior hollow 12. The ledge 28 ensures that the second portion 21 of the nozzle 20 is retained above, and outside of, the heating body 18 during use (i.e. to be exposed to ambient atmosphere (e.g. air), as set forth above). The exterior surface 31 that is proximal to the outlet 24 is, effectively, directly heated by the coils 15, whereas the second portion 21 is only indirectly heated by the coils 15 (i.e. by virtue of heat conduction). This means that the second portion 21 of nozzle 20 is maintained at a cooler temperature relative to the rest of the nozzle 20, with the attendant benefits as outlined above.

FIG. 3 also shows that the heater in the form of the resistive coils 15 is located within the heating body 18 (i.e. between the sleeve 14 and block 16) so as to not extend beyond a lower end of the block 16/body 18 (e.g. so as not to extend into a temperature-controlled chamber 60, as described in more detail below). For example, as shown, the coils 15 may be spaced inwardly from a lower end of the annulus 17, surrounding only that part of the nozzle 20 that is in direct thermal 0 contact with sleeve 14.

Likewise, a bulk of the nozzle 20 (i.e. especially the part that is in direct thermal contact with sleeve 14) does not extend beyond a lower end of the block 16/body 18 (i.e. thereby also not extending into the temperature-controlled chamber 60). This means that the heat produced by the resistive coils 15 is mainly directed into the block 16/body 18 and into nozzle 20 and does not overheat the surrounding environment (including the temperature-controlled chamber 60). This arrangement also allows for better and more precise temperature control of nozzle 20.

The heating body 18 can be formed as a block shape, such as cylindrical, polygonal or any other suitable shape that is capable of performing the above described functions. In a variation, the heater can be incorporated into the heating body 18 (e.g. to be integrated into/within block 16), such that the block 16 heats the nozzle 20 where it is in direct thermal therewith. For example, heat-producing resistive coils can be located within passages that are formed (e.g. machined) into block 16, such that the coils do not directly contact the sleeve 14 or nozzle 20. Typically, when the heater is incorporated into the block 16 of the heating body 18 it locates in adjacency of the sleeve 14/nozzle 20 (i.e. locates ‘at’ the hollow).

In use, the heating body 18 is heated to produce the requisite thermal energy when connected to an electric power source. The heating body heats the nozzle 20 to facilitate melting and extrusion of the feedstock 10. As set forth above, typically the nozzle 20 is heated by the heating body 18 to a temperature that is higher than the softening temperature and considerably higher than the annealing temperature of the material (e.g. glass). This serves to prevent the feedstock material from solidifying within the nozzle 20 and thus be unable to be extruded through the nozzle.

By way of example, when printing glass (e.g. Bullseye (soda lime) glass), the glass can have an annealing temperature of 482° C. Thus, the printing nozzle temperature can set to be as high as e.g. 900° C. This is expanded on in further detail below.

The thermal energy produced by the resistive coils 15 can be controlled by a proportional—integral—derivative (PID) system, for example, by using a thermocouple and a predetermined target temperature. The use of heat producing resistive coils 15 combined with an effective enclosure of high temperature insulative material for block 16 allows for high temperatures to be reached within the nozzle 20 whilst drawing a relatively low power input compared to laser or induction heating methods. For example, testing of the disclosed 3D printer system 100 has indicated that as little as 250W may be required to effectively power the heat producing resistive coils 15 so as to extrude feedstock made from Bullseye soda lime glass. This represents a substantial simplification of and advancement over prior art 3D printers.

As would be appreciated by one skilled in the art, other forms of heating are also contemplated within the functional intent of the present disclosure. For example, a laser heating-, combustion heating-, or induction heating-system could be used, although these may not be as compact or economical as heat-producing resistive coils.

Again, in use, the thermal energy generated by the heating body 18 is sufficient to raise the temperature within body 26 of nozzle 20 to a predetermined temperature at which the material viscosity of the feedstock 10 is lowered enough whereby, in combination with the increasing pressure that builds as additional feedstock 10 is fed into the nozzle 20, the feedstock 10 flows down and out through the nozzle outlet 24. The feedstock 10 can thus be extruded from the nozzle 20 in a controlled manner onto the upper surface of the print platform 80. For example, the predetermined temperatures for sufficiently melting glass can range between 700° C. and 900° C., although in some embodiments, the disclosed 3D printer can be used at temperatures above 1000° C.

Notwithstanding that the second portion 21 of nozzle 20 is relatively cooler than the rest of the nozzle body 26, the entire nozzle 20 is still sufficiently heated. This enables feedstock 10, such as glass rod, to be fused together at the top of the nozzle 20 proximal to the nozzle inlet 22. Further, the temperature of the second portion 21 of the nozzle 20 can still be raised by the heating body 18 to be sufficient for fusing adjacent segments of feedstock 10 together. This can serve to reduce instances of air bubbles within the molten feedstock 10, which bubbles can undesirably affect the continuity of the extrusion, reduce the quality of the printed product, and thus be detrimental to the printing process. In addition, by fusing feedstock 10 at the top of the nozzle 20, a separate fusing station is not required by the 3D printer system 100 which can improve the compactness of the system, reduce cost, and can also reduce the power required to operate the system.

The length of the second portion 21 of the nozzle 20 that is exposed to ambient air is carefully determined. In this regard, the longer the length of the second portion 21, the higher the amount of the force required from the extrusion system 40 in order to effectively drive the feedstock 10 into the nozzle 20. A long second portion 21 results in cooler feedstock material 10 at the nozzle inlet 22, the feedstock thereby having a higher viscosity, and thus higher resistance against flow and extrusion. By contrast, with too short (or no) length of the second portion 21 being exposed to ambient air, the higher the risk that the feedstock 10 material will become too heated and thereby too soft. When the feedstock material 10 becomes too soft, the molten feedstock can resist being driven to thereby flow in a controlled manner through the nozzle to be extruded effectively from the nozzle outlet 24. Instead, the excessively soft molten feedstock 10 can form a molten pool proximal the nozzle inlet 22. A ‘pooling’ effect can result in feedstock backflow, spill-over, leakage, etc. and can thus be considered undesirable.

The size and shape of the nozzle outlet 24 can also be designed/selected and used to dictate the resolution of the extruded material. For example, the nozzle outlet 24 can be formed to have a circular shape with a diameter that corresponds to the resolution desired for the printed product. As would be understood by one skilled in the art, a variety of outlet shapes (e.g. triangular, square, polygonal, ovular etc.) and a variety of resolution sizes are possible. The size and shape of the nozzle inlet 22, nozzle interior hollow 25, and nozzle outlet 24 can thus be varied to print different materials or across a range of different resolutions.

As shown in FIG. 5, to configure the nozzle outlet 24 with a smaller size (e.g. width or diameter) than the nozzle interior hollow 25 of the nozzle body 26, the nozzle interior hollow 25 can comprise an internal chamfer 27 at the junction where the step-down in size occurs. For example, common printing resolutions typically can range between 0.5 mm and 4 mm. The nozzle outlet 24 can thus be formed to have a corresponding cross-sectional width for the desired printing resolution. Printing at higher resolutions means that the cooling deposited layers of feedstock can have a lower thermal mass because they are smaller. This can help reduce the amount of thermal stresses (e.g. shear and tension forces) that are generated between printed layers.

As set forth above, it can be advantageous that the nozzle 20 is removable and interchangeable in a singular 3D printer system 100. The 3D printer system 100 can thus be used to print a variety of feedstock materials and across a range of resolutions without requiring extensive and costly reconstructions of the entire heating body 18 and nozzle 20 assembly.

To promote the passage of molten feedstock through the nozzle 20 from the inlet 22 to the outlet 24 various parameters can be controlled. These include: viscosity of the molten feedstock; nozzle temperature; nozzle dimensions; feedstock dimensions; flow rate of feedstock into/exiting the nozzle; and temperature of the printing environment (e.g. of a temperature-controlled chamber 60 into which the an article is printed, as set forth below). Typically, each of molten feedstock viscosity, the dimensions of the nozzle 20, the size/dimensions of the feedstock 10, feedstock flow rate, and nozzle/print chamber temperature used to print a 3D product are carefully selected in order to balance the various effects altering each can have on the ability to effectively produce a 3D product (e.g. of high quality).

As set forth above, each or all of these parameters can be controlled as part of the system 100. Such control can also include preconfiguring, pre-setting, pre-programming, etc. of each parameter. For example, a parameter can be controlled by setting or determining or establishing it from or before the outset of a printing operation/process. Thereafter, it may not vary (or may not need to be varied).

For example, for a nozzle 20 having an inlet 22 of diameter 4 mm, an outlet 24 of diameter 1.5 mm, an overall nozzle length of 112 mm, a second exposed portion 21 of length 10 mm, that is fed with feedstock 10 having a diameter of 4 mm, at a speed of 6 mm/second and at a layer height of 0.5 mm, the effective nozzle temperature in order to produce a 3D print from Bullseye soda lime glass will be between 800° C. and 950° C., in conjunction with the temperature-controlled chamber 60 being set to a temperature of 500° C.

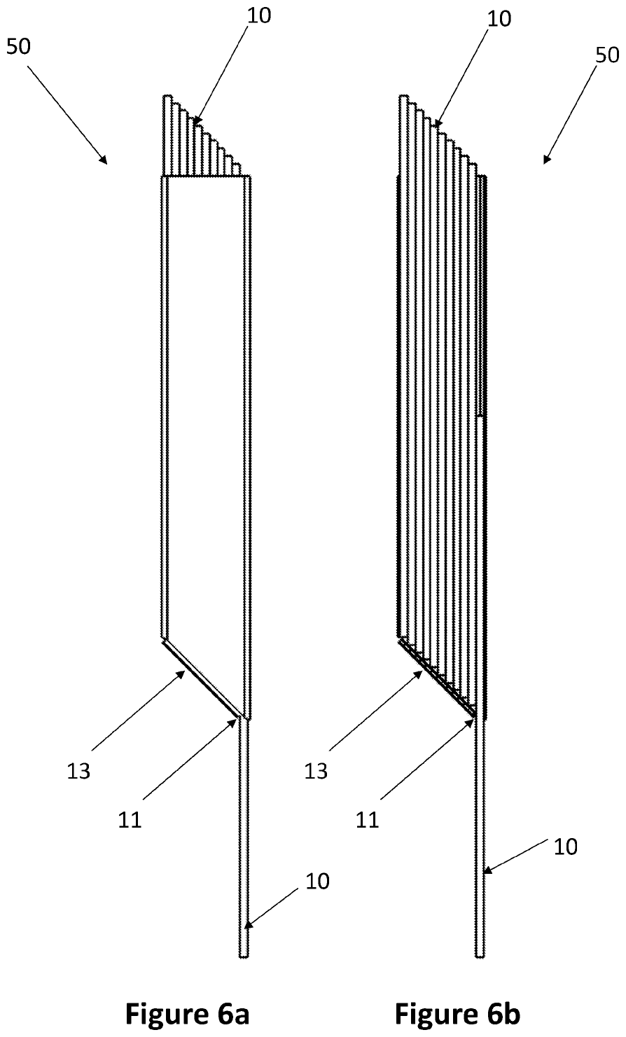

The feeder system 50 for feedstock 10 can take a number of forms. For example, with reference to FIGS. 6A and 6B, the feeder system 50 can be configured to feed the feedstock 10 under the force of gravity into the extrusion system 40. As one section, or rod, of feedstock 10 falls under the force of gravity down into the extrusion system 40 a further section, or rod, of feedstock 10 can slide towards the aperture of the loading position 11 along the downwardly sloped lower surface 13 of the feeder system 50. Thus, each section of feedstock 10 is immediately followed by a further section of feedstock 10 in a generally smooth transition process.

Alternatively, the feedstock can be fed as a single continuous piece, for example, from a Vitrigraph (not shown) which is essentially a kiln with a hole in the bottom thereof that allows molten feedstock material to be pulled out therethrough in order to feed a solid or semi-solid feedstock material into the extrusion system. The Vitrigraph can be used to combine solid material such as powder, crushed glass, scrap, fragments etc. before feeding the resulting feedstock as a continuous rod into the extrusion system.

To prevent dripping of molten feedstock 10 during movements and displacements that the 3D printer system 100 performs during 3D printing, feedstock retraction can be performed. Retraction is a recoil movement of the feedstock 10. Retraction can be initiated by the extrusion system 40 ceasing to drive the feedstock 10 towards the nozzle 20, or by the extrusion system 40 reversing the direction of drive of the feedstock 10 away from the nozzle 20. When the feedstock 10 comprises a plurality of discrete segments, a segment of feedstock 10 that has already passed through the extrusion system 40 can no longer be retracted. Thus, there will be a short amount of time, following the segment passing through the extrusion system 40, during which retraction is not possible. A single continuous feedstock may thus improve the performance of the 3D printer system when temporarily stopping the extrusion process during a retraction, as the extrusion system 40 can maintain continuous engagement with, and thus control over, the feedstock 10. A single continuous feedstock may also reduce instances of undesirable air bubbles in the feedstock and may remove the need for an additional component in the 3D printing system that can fuse the feedstock.

The extrusion system 40 is typically a motorised driving mechanism that controls the rate of flow of the feedstock 10 into the nozzle 20. The extrusion system 40 has the ability to control the start, stop or variance of the extrusion flow rate, as desired and with a high level of precision. For example, the extrusion system 40 can use a computer numerical control (CNC) or similar mechanism to control the flow rate of feedstock 10. With particular reference to FIGS. 1 to 3, the extrusion system 40 comprises a plurality of wheels 38, each being spaced from one another so as to locate on an opposing side of, and to engage with, the feedstock 10 that passes therebetween. Each wheel 38 of a pair of such opposing wheels turns in an opposite direction, an outer circumference of the wheel interacting with, and providing a friction force against, the feedstock 10 located therebetween so as to controllably drive the feedstock with an in-use downwardly moving pressure towards the nozzle inlet 22. A person skilled in the art would appreciate that the extrusion system 40 can also enable the 3D printer system to be used in other orientations (e.g. horizontal) as the system is not reliant on gravity alone in order to extrude feedstock from the nozzle. In an alternative, not shown, a single wheel can be used to drive the extrusion system, with the feedstock held against an opposing frictionless support/guide surface.

In another example, and with reference to the embodiment shown in FIGS. 7 to 11, the extrusion system 40′ can comprise a motor 37 that drives a belt 36 that passes over the outer circumference of one of the wheels 38′. The belt 36 can be formed to have an outer layer that exhibits a relatively high level of friction against the feedstock 10. Advantageously, the belt 36 can be replaced when it becomes worn over time due to the friction and heat. The wheels 38′ of the extrusion system 40′ can be spring-loaded whereby the two opposing wheels 38′ of a pair are able to resiliently adjust their relative position (i.e. relative spacing width from each other) to account for variation in feedstock size and straightness whilst maintaining the application of sufficient friction force against the feedstock 10 therebetween so as to be capable of driving the feedstock with an in-use downward pressure force towards the nozzle 20. For example, in some forms the wheels 38′ can be spring-loaded to adjust ±2 mm from a nominal feedstock diameter. The extrusion system 40, 40′ can increase the precision with which the molten feedstock can be controllably extruded from the nozzle outlet 24 because the 3D printer system 100 is not solely reliant on the force of gravity to drive the extrusion. The extrusion system 40, 40′ can also improve the performance of the 3D printer system when temporarily stopping the extrusion process during a retraction. For example, it can be advantageous to use an extrusion system 40, 40′ when printing for high end applications, where there can be a need for precise control over the volumetric flow rate and extrusion of molten feedstock material.

In order to guide the feedstock 10 through the extrusion system 40, 40′ and into the inlet 22 of the nozzle 20, some embodiments of the 3D printer system 100 can utilise one or a plurality of guides such as guide blocks 30. The guide blocks 30 can be used to ensure that the feedstock 10 stays aligned with the nozzle inlet 22 whilst passing through, and being driven downwards by, the extrusion system 40, 40′.

For example, a guide block 30 can be located above the entry 42 and below the exit 44 of the extrusion system 40 (e.g. FIGS. 1 to 3). The guide block 30 can be formed from metal such as steel or aluminium into a block that comprises a channel therethrough. The channel is shaped and provided with a diameter that allows the feedstock 10 to freely move therethrough into the nozzle 20, whilst substantially restricting lateral movement away from the central axis of the feed path followed by the feedstock 10. In addition, a chamfered region 29 can be formed proximal to the nozzle inlet 22, the chamfer assisting with smoothly guiding feedstock 10 into the nozzle interior hollow 25. The guide blocks 30 may advantageously reduce, or remove, the need to fuse individual rods of feedstock 10 together prior to passing through the extrusion system 40. Instead, the aligned segments of feedstock 10 can be fused together by the heat within the nozzle 20 as they pass into the inlet 22 and enter the second portion 21 of the nozzle 20. This can allow the 3D printer system to be more compact in overall size and can also reduce the overall cost of manufacturing such a 3D printer system.

As would be appreciated by one skilled in the art, whilst the guides can take the form of blocks 30, other variations are also contemplated, such as where plates or rings are used to align and guide the feedstock through extrusion system 40 and into the nozzle inlet 22. Other materials are also contemplated for the guide blocks 30, provided that the material can thermally withstand an elevated ambient temperature due to heat radiating from the heating body 18.

Molten feedstock 10 is extruded out of the nozzle 20 through the nozzle outlet 24 and onto a print platform 80 that is arranged within a temperature-controlled chamber 60. The temperature-controlled chamber 60 is configured to control and regulate the temperature of the 3D product during the printing process that occurs therein.

In this regard, the temperature within the temperature-controlled chamber 60 can be controlled to be above the annealing temperature of the feedstock material. Once printing of an article/product has been completed, the temperature within chamber 60 can be reduced to the annealing temperature of the material. Likewise, the temperature of the nozzle outlet 24 can be controlled to be the higher than the softening temperature of the material. This control can allow for the material to be easily extruded/printed and then controllably annealed whereby internal stresses between layers of the printed 3D product may be at least partially relieved. This may reduce the likelihood of the printed 3D article/product breaking due to internal stresses or thermal shock which can otherwise occur if the printed 3D article/product is exposed to rapid cooling. This control can also help the 3D printing system to print more complex geometries.

It will be seen that the heating body 18 is installed generally centrally at an in-use upper surface 62 of the temperature-controlled chamber 60. The nozzle 20 is retained within the heating body 18 such that the nozzle outlet 24 only slightly extends beyond the lower surface of the heating body 18 to barely project into the temperature-controlled chamber 60. The temperature of the feedstock 10 at the nozzle outlet 24 is controlled by the heating body 18 (i.e. amount of current sent to the heat-producing resistive coils 15). The temperature of the feedstock at the nozzle outlet 24 can be set to ensure that the printed glass will adhere to the print platform 80 during the initial deposition. Likewise, the temperature of the temperature-controlled chamber 60 can be selected and controlled such that, following extrusion from the nozzle outlet 24, the feedstock temperature remains above the minimum temperature at which the deposited material will be likely to adhere to the print platform 80. If the temperature of the temperature-controlled chamber 60 is too low, then the extruded feedstock 10 will cool too quickly, and as such will not adhere to the print platform 80 when deposited. Conversely, if the temperature of the temperature-controlled chamber 60 is too high, then the extruded feedstock 10 may overly adhere to the print platform 80 when deposited. In such instances, the printed product may thus be difficult to release from the print platform 80 once it has annealed.

Printing inside the temperature-controlled environment of the chamber 60 can, through annealing, help with reducing the thermal shock experienced by the deposited feedstock following extrusion. The temperature-controlled chamber 60 can thus allow for the fabrication of 3D products having a wide range of thicknesses and complexities. In addition, printing at high resolutions and within the temperature-controlled chamber 60 can reduce, or even substantially eliminate, the shear and tension forces that can be generated between printed layers, thereby allowing the printing direction to change rapidly without causing large and undesirable stresses.

During the 3D printing process, the temperature within the temperature-controlled chamber 60 can be selected to ensure that the freshly extruded molten feedstock will adhere to the already printed section of the 3D product on the print platform 80. As above, the selected temperature is typically a temperature that is higher than the annealing temperature of the material being printed. After the extrusion step of the printing process has been completed, the temperature of the temperature-controlled chamber 60 can be lowered to the annealing temperature so that the 3D printed article/product can be relieved of stresses and the article/product can be released from its adhesion to the print platform 80 prior to removal from the chamber 60.

The print platform 80 is configured to be movable along three axes relative to the nozzle outlet 24, with the origin of the two horizontal axes being located approximately colinearly with the central axis through the nozzle 20. For example, the print platform 80 can be moved along the two horizontal axes (i.e. x and y axis), and along the vertical axis (i.e. z axis), within the boundaries of the temperature-controlled chamber 60.

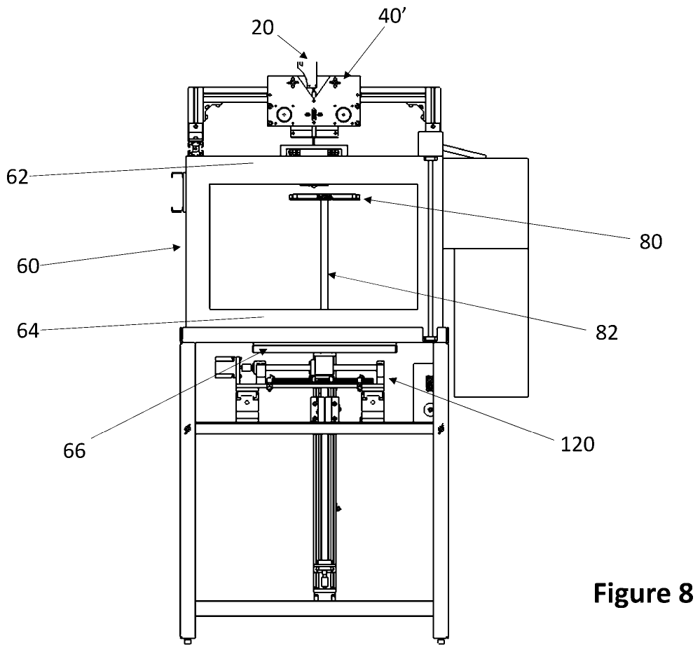

The movement of the print platform 80 is controlled by a computer program that moves the print platform 80 along a pre-programmed route relative to the fixed position of the nozzle outlet 24 so as to form the 3D article/product. For example, an actuation system 120 (FIG. 8) that uses CNC can control and move the print platform 80 in a manner that is synchronised and corresponds to the extrusion flow rate controlled by the extrusion system 40 in order to produce 3D printed objects. The actuation system 120 can employ various known linear actuators.

The print platform 80 sits atop a print platform support 82 which extends downwardly and outside of the temperature-controlled chamber 60 where it connects to, and is driven to move along three axes by, the actuation system 120.

An insulation plate 66 is used to cover the aperture 68 through the in-use base surface 64 of the temperature-controlled chamber 60, and through which the print platform support 82 protrudes into the temperature-controlled chamber 60. The insulation plate 66 insulates around the aperture 68 and assists with maintaining the temperature within the temperature-controlled chamber 60 efficiently (see e.g. FIGS. 1, 2, and 8).

The print platform 80 can be formed from a kiln shelf that is coated with a high temperature powdered release agent, such as kiln wash or batt wash. A suitable kiln wash is supplied by Bullseye Glass Co. and comprises aluminium trihydroxide, kaolin and silica. The release agent is mixed with water and is typically sprayed onto a surface of the platform 80. Once the platform is coated, it can be dried to remove the water leaving the powdered agent behind (e.g. at a temperature of 80-100° C.). The remaining powdered agent forms a thin film or layer that acts as a barrier between the platform and the 3D printed product.

When applied correctly, the kiln wash can allow the printed 3D product to adhere to the print platform 80 at the temperature selected for the chamber 60. After cooling of the printed article/product, the release agent also allows for its easy removal. As above, the chamber temperature selected can, for example, be higher than the annealing temperature. Using a temperature higher than the annealing temperature can help reduce adherence to the 3D printed product once annealed.

The temperature of the nozzle 20 and temperature within the temperature-controlled chamber 60 can both affect the flow characteristics of the extruded feedstock 10. For example, the temperature of the nozzle 20 and temperature-controlled chamber 60 can be accurately controlled using thermocouples that are integrated with proportional-integral-derivative (PID) control. Flow characteristics of the extruded feedstock 10 can also be varied, depending on the stage of the printing process, to affect the behaviour of the molten feedstock between the nozzle outlet 24 and the print platform 80.

The flow characteristics of the extruded feedstock can predominantly depend on the temperature of the extruded feedstock at the nozzle outlet 24 and the cooling process which begins to take place instantly as the feedstock 10 is extruded from the nozzle outlet 24. The temperatures of the nozzle 20 and within the temperature-controlled chamber 60 can be set so that the viscosity of the feedstock 10 is lowered adequately whereby extrusion is possible and the printed layers of feedstock can adhere to one another. However, the temperature of the nozzle 20 and within the temperature-controlled chamber 60 should also not be excessively high, so that the feedstock 10 can still cool quickly enough following deposition in order to solidify and maintain the desired 3D printed shape. By contrast, if the temperature of the extruded feedstock at the nozzle outlet 24 and/or the temperature of the chamber 60 are/is too low, then the extruded feedstock may not adhere to the print platform 80 adequately. This may degrade, or in some embodiments ruin, the quality of the 3D printed product.

For example, the viscosity of glass feedstock can change in many orders of magnitude during a printing process. The glass feedstock can be soft enough for extrusion as it passes through the nozzle outlet but can already be essentially solid once cooled and when the annealing begins on the print platform 80. Depending on the temperatures of the nozzle 20 and temperature-controlled chamber 60, in combination with the various printing settings which effect the rate of material being deposited (for example the layer height, line width, print speed, nozzle outlet size) the solidification process can be substantially immediate, or take a very brief amount of time, for example, less than 2 seconds. For geometrical accuracy, it may be desirable for the solidification to be substantially immediate. If the temperature of the glass feedstock in the nozzle 20 is too low then the viscosity of the glass feedstock will be high, whereby the glass feedstock will be overly resistant to flow, making effective extrusion difficult.

As a further example, for soda lime glass typically used in kiln forming, the temperature-controlled print chamber can be maintained approximately up to 50° C. above the annealing temperature. This can assist with relieving any internal stresses during print. For example, the temperature-controlled chamber can be set to a temperature between 482° C. and 532° C. which is equal to or above the annealing temperature of 482° C. for Bullseye glass (which is a type of soda lime glass). The temperature at the nozzle outlet 24 can be maintained between 800° C. and 950° C. Such temperatures allow for adequate softening of the feedstock whereby the extrusion system can effectively drive and control the flow of the extrusion. Other types of soda lime glass can require that different temperatures be selected for the nozzle outlet and temperature-controlled chamber, as the material composition, even when slightly changed, can cause relatively large changes to the material properties, such as how viscosity is affected by the temperature of the glass.

The temperature ranges for the nozzle outlet 24 and the temperature-controlled chamber 60 can be predetermined in isolation from one another. Once suitable temperature ranges have been established based on the specific material properties of the feedstock 10, the selected temperatures can be further optimised through an iterative experimentation process. For example, if the solidification of the extruded feedstock 10 is not quick enough, one or both of the nozzle outlet 24 and the temperature-controlled chamber 60 temperatures can be lowered. If the feedstock 10 is oozing from the nozzle 20, the nozzle outlet 24 temperature can be decreased. By contrast, if the first layer of extruded feedstock 10 is not adhering to the print platform 80 adequately after being deposited, one or both of the temperatures can be increased.

The printing speed, the layer height, the cross-section width of the nozzle outlet 24, and the composition of the feedstock 10 material can also affect the flow characteristics of the extruded feedstock 10.

For example, higher print speeds can cause the feedstock to cool more quickly as the heat of the hot nozzle 20 is quickly moved further away from newly deposited feedstock. By contrast, if the print speed is too slow, the heated low viscosity feedstock 10 can pool at the nozzle inlet 22 due to the excess in time allowed to absorb heat. This can reduce the ability of the extrusion system 40 to drive the feedstock 10 and effectively control the flow rate of the extrusion from the nozzle outlet 24.

As a further example, larger layer heights or larger cross-sectional width nozzle outlets 24 can result in a larger volume of feedstock 10 to be extruded at a given time. This can cause the deposited feedstock to cool more slowly due to the larger relative size of the thermal mass. By contrast, smaller layer heights and/or smaller cross-sectional width nozzle outlets 24 can increase the risk of the heated low viscosity feedstock 10 pooling adjacent the nozzle inlet 22, as the extrusion from the outlet 24 can be slower. To counter this, it may be necessary to optimise other input parameters of the 3D printer system. For example, the cross-sectional width of the feedstock can be reduced.

Once the temperature and dimensions of the 3D printing system 100 are optimised, a 3D printed article/product can be formed that readily maintains its shape and that can anneal adequately to relieve internal stresses. Different feedstocks have unique viscosity vs temperature curves, as well as other properties which can affect the 3D printing process as described above. There may also be further considerations to be made, such as considering the coefficient of thermal expansion of the feedstock material. As such, the configurations of the 3D printing system 100 may need to be adjusted in order to be optimised for each individual feedstock.

Slicing is a term that refers to taking a computer model, applying various 3D printing settings such as layer height, print speeds, temperatures, viscosity, flow rates, etc. and then forming computer programming code which can control the 3D printing process. An FDM slicing program can be used to process the 3D model in layers from which computer programming code can be produced. A sliced 3D model provides the computer programming code which can then be fed to the 3D printer system computer which then controls the various components of the 3D printer system 100 in order to manufacture the 3D printed product. The 3D printer system 100 can print a first layer before moving on to the next and so on.

For example, a modified polymer FDM slicing program, such as Cura, can be used to create a gCode to control the 3D printer system for a variety of other feedstock materials, including glass for example. When using a modified polymer FDM slicing program, comparable speeds, resolutions and filament diameters can be used so that the already highly developed slicing software used in polymer 3D printers can be modified for use in printing other types of feedstock material. The 3D printer system 100 may thus be able to print a 3D product with high resolution, control and clarity from a range of glass material inputs using an FDM approach.

The 3D printer system 100 provides a relatively high level of user control. The ability to control the various variables described above with high precision can enable the 3D printer system 100 to produce high quality 3D printed products.

The method of printing with the 3D printer system 100 begins with the feeder system 50 feeding feedstock 10 into the extrusion system 40. The extrusion system 40 then drives the feedstock 10 downwardly into the nozzle 20 that is heated by the heating body 18. Once the feedstock 10 has melted sufficiently within the nozzle 20, the molten feedstock is extruded through the nozzle outlet 24 by the combined force of the extrusion system 40 and gravity. The extruded molten feedstock is deposited on the print platform 80 that moves in a controlled manner within a temperature-controlled chamber 60. The print platform 80 is moved through a pre-programmed path by the actuation system 120 that is in turn controlled by a computer and that can move in synchronisation with the flow rate generated by the extrusion system 40, so that e.g. bespoke objects/articles can be fabricated. Once extrusion has been completed, the 3D printed product is then held at its annealing temperature for a period of time in order to relieve internal stresses. Finally, the 3D printed product is dislodged from the print platform 80 with mechanical force and allowed to cool to room temperature.

As set forth above, one of the major issues that arises during 3D printing of materials at high temperature is that of nozzle backflow or pooling. The present system is able to minimize pooling through strict process control while seeking desired product characteristics. By controlling parameters selected from a group comprising viscosity of molten feedstock, nozzle and chamber temperature, nozzle dimensions, feedstock dimensions and speed of printing, it is possible to create conditions in the system that promote the passage of the molten feedstock through the outlet while maintaining desired product characteristics. For example, it is possible to increase the layer height from 0.5 mm to 1 mm in case it is desired to fabricate an artistic piece. In order to perform the process at the same print speed, the feedstock can be moved at twice the speed as previously (because more material is now required to be deposited). This in turn results in the pressure increasing in the nozzle (i.e. there can be too much resistance to flow) and this can lead to pooling. However, by reducing the speed of printing, it is possible to reduce the pressure in the nozzle (as more time is available for the material to exit the nozzle) thereby preventing pooling/backflow. Therefore, no additional mechanisms (such as cooling the top of the nozzle) are required to prevent such pooling/backflow. By choosing the combination of parameters carefully, articles/products with a desired range of characteristic can be produced.

Variations and modifications may be made to the parts previously described without departing from the spirit or ambit of the disclosure.

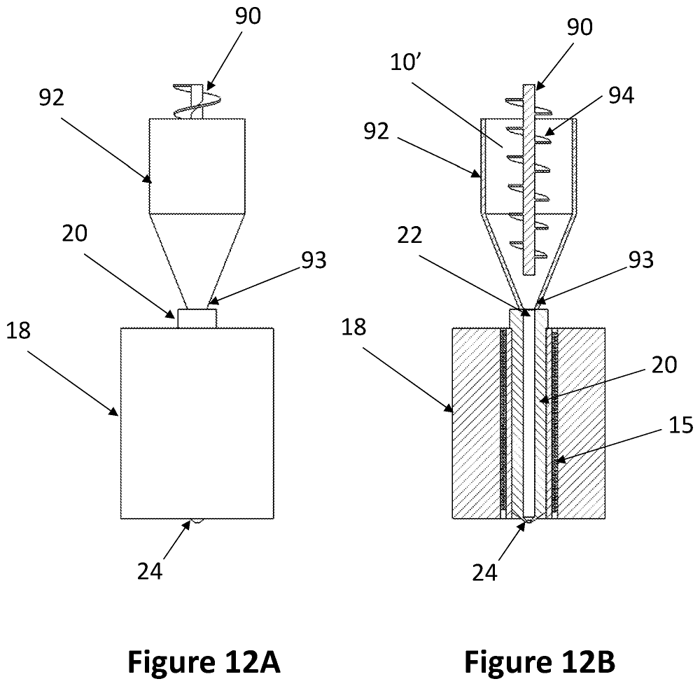

For example, in one such variation, and with reference to FIGS. 12A and 12 B, the extrusion systems 40, 40′ as set forth above can be replaced with an auger 90 that operates within a mixing chamber 92. The auger 90 is a threaded screw-like 5 mechanical system where, upon rotation, the thread 94 forces the feedstock 10′ material within the mixing chamber 92 to flow towards the mixing chamber outlet 93 (i.e. in a downward direction). The mixing chamber outlet 93 locates adjacent to, and is in fluid connection with, the nozzle inlet 22, whereby the molten and mixed feedstock 10′ is driven into the nozzle 20. An auger 90 and mixing chamber 92 system can be used to widen the range of materials that are able to be used as feedstock inputs. These feedstock material inputs may include, for example, one or more of cullet, powder, fines or any combinations of these types of glass. Various material forms can also be accepted. For example, glass powder and cullet can be placed inside the mixing chamber 92 and driven down into the nozzle 20 by the motorised auger 90. A feeder system can be configured to supply feedstock materials into the mixing chamber 92. In a manner similar to the extrusion systems 40, 40′ described above, the auger 90 can be used to provide a force that pushes the feedstock 10′ into the nozzle 20, thereby enabling for start, stop, and flow rate of the extrusion to be controlled. If the feedstock 10′ in the mixing chamber 92 is not a powder, it may require some heating to ensure that the viscosity of the feedstock 10′ is lowered enough for the auger 90 to rotate and force to the feedstock 10′ into the nozzle inlet 22.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the printing apparatus, system and method.

1-41. (canceled)

42. A printing apparatus for 3D printing of feedstock, the printing apparatus comprising:
a hollow nozzle having an inlet at a distal end thereof and an outlet;
a holder for supporting the nozzle in use, the holder comprising a hollow therethrough to receive the nozzle therein;
a heater for the nozzle, the heater being located within the holder between the holder and the nozzle, the heater configured to surround a first portion of the nozzle to heat the feedstock as it is fed through the nozzle from the inlet to the outlet;
wherein the nozzle is mounted within the heater located within the holder such that a nozzle exterior surface located at the first portion of the nozzle and proximal to the outlet is surrounded by the heater, the nozzle exterior surface extending to a second portion of the nozzle that is proximal to the inlet such that the exterior surface of the second portion of the nozzle locates outside of and extends away from the heater and the holder at the nozzle distal end to be exposed to ambient atmosphere.

43. The printing apparatus as claimed in claim 42, wherein, a temperature of the nozzle varies across the nozzle whereby the feedstock proximal to the inlet is more viscous than the feedstock proximal to the outlet.

44. The printing apparatus as claimed in claim 42, wherein the heater comprises a heating element, the heating element being one or more heat producing resistive coils, the heater optionally comprising one or more layers of insulation, such as a refractory material, around the heating element, and wherein the insulation is arranged between adjacent windings of the one or more resistive coils to thereby support the coils in use.

45. The printing apparatus as claimed in claim 42, wherein the feedstock is forced to be extruded through the outlet of the nozzle by one or more of a driving mechanism and/or gravity.

46. The printing apparatus as claimed in claim 45, wherein the driving mechanism applies a driving force against the feedstock in-use, whereby the feedstock is forced to move towards the nozzle outlet.

47. The printing apparatus as claimed in claim 45 , wherein the driving mechanism comprises two wheels, the two wheels being spaced from each other so as to locate and apply the driving force against opposing sides of the feedstock, each of the two wheels optionally being able to resiliently move so as to adjust a width of the spacing relative to the opposing one of the two wheels whilst maintaining the application of the driving force against the feedstock in-use.

48. The printing apparatus as claimed in claim 42, wherein the feedstock is supported to be in alignment with, and guided into, the nozzle inlet by one or more guides.

49. The printing apparatus as claimed in claim 45, wherein the driving mechanism comprises an auger within a mixing chamber, the auger being configured to apply the driving force against the feedstock.

50. The printing apparatus as claimed in claim 42, wherein the feedstock comprises a viscoelastic material such as glass or glass-ceramic material.

51. The printing apparatus as claimed claim 42, wherein the nozzle is removable from the heater.

52. The printing apparatus as claimed in claim 42, wherein the nozzle is formed from a conductive material or a non-conductive material.

53. The printing apparatus as claimed in claim 42, wherein the printing apparatus can be operated at temperatures between 700 and 900 degrees Celsius or at temperatures above 1000 degrees Celsius.

54. The printing apparatus as claimed in claim 42, wherein, in use, a temperature of the outlet is higher than the softening temperature of the material of the feedstock.

55. The printing apparatus as claimed in claim 42, the printing apparatus further comprising a sleeve that is configured for location within the hollow of the holder whereby the nozzle is able to be located within the sleeve in use.

56. The printing apparatus as claimed in claim 55, the apparatus being configured such that the heater is located in adjacency of the sleeve, between the sleeve and the holder.

57. A printing apparatus for printing of feedstock onto a platform in three-dimensions, the printing apparatus comprising:
a temperature-controlled chamber in which the platform is located, the temperature-controlled chamber able to be heated to a temperature that is suitable for printing of the feedstock onto the platform;
a hollow nozzle having an inlet and an outlet, the nozzle comprising a first portion located proximal to the outlet and a second portion located proximal to the inlet;
a holder for supporting the nozzle in use, the holder comprising a hollow therethrough to receive the nozzle therein;
a heater for the nozzle, the heater being located at or within the holder so as to not extend into the chamber, the heater being configured to surround the nozzle when located therein to heat the feedstock as it is fed through the nozzle from the inlet to the outlet.

58. The printing apparatus as claimed in claim 57, wherein the temperature-controlled chamber is configured such that:
during printing of the feedstock onto the platform the chamber is able to be heated to a temperature that is above an annealing temperature of the material of the feedstock;
after printing, the temperature of the chamber is able to be reduced to the annealing temperature of the material of the feedstock.

59. The printing apparatus as claimed in claim 57, wherein the nozzle is mounted within the heater located within the holder such that a nozzle exterior surface located at the first portion of the nozzle and proximal to the outlet is surrounded by the heater, the nozzle exterior surface extending to a second portion of the nozzle that is proximal to the inlet such that the exterior surface of the second portion of the nozzle locates outside of and extends away from the heater and the holder at the nozzle distal end to be exposed to ambient atmosphere.

60. A method of printing feedstock in three-dimensions, the method comprising:
locating a hollow nozzle in a holder, the nozzle having an inlet at a distal end thereof and an outlet;
passing the feedstock through the hollow nozzle,
directly heating a first portion of the nozzle proximal to the outlet by a heater located between the holder and the nozzle, and passively cooling only a second portion of the nozzle proximal to the inlet by exposing an exterior surface of the second portion at the distal end to ambient atmosphere.

61. The method as claimed in claim 60, wherein the first portion of the nozzle is heated by a heat source, and wherein, in addition to passive cooling, the second portion of the nozzle is indirectly heated by the same heat source such that, in use, the second portion of the nozzle is cooler than the first portion of the nozzle.
